(19) United States
(12) Patent Application Publication
(10) Pub. No.: US 2004/0117400 A1
(43) Pub. Date: Jun. 17, 2004

(54) Method and apparatus for requesing information

(76) Inventors: Daniel T. McCrystal, Leesburg, VA (US); Robert Eubanks, Lessburg, VA (US); Kelly Neal Ford, New York, NY (US)

Correspondence Address: GLENN PATENT GROUP, 3475 EDISON WAY, SUITE L, MENLO PARK, CA, 94025, US

(21) Appl. No.: 10/317,517

(22) Filed: Dec. 11, 2002

(51) Int. Cl. G06F 17/00

(52) U.S. Cl. 707/104.1

(57) ABSTRACT

In a presently preferred embodiment, the invention comprises a method for providing electronic information, which comprises the steps of providing a user of an electronic device with access to a Web page hosted by a first party, which Web page includes content from the first party, and which also includes content from a second party. The content from the second party relates to a subject. When the user responds to the content from the second party, e.g. by clicking on the Web page, to request additional content on the subject, the user automatically accesses a destination address, and the requested additional content is automatically sent to a destination address for use by the user independently of the user's current Web navigation session.

### BACKGROUND OF THE INVENTION

1. Technical Field

The invention relates to electronic networks. More particularly, the invention relates to the display of information at a user location via an electronic network and the selection by the user to receive additional information by interacting with a web page.

2. Description of the Prior Art

The Internet and the navigation of Web pages through a browser are so well established in everyday life that it is sometimes difficult to appreciate that the Internet and browsers are only a recent development. It is now common for individuals to receive their news, to shop, and to communicate with others via the Internet using a Web page metaphor. In connection with such use of the Internet and the World Wide Web, it is common for users to interact with Web pages by clicking on portions of the Web page to receive a linked piece of information.

Recognizing this ability to link information to Web pages, advertisers have eagerly placed so called banner ads on Web pages in the hopes that a user clicks through to the advertiser's Web site via the banner ad to receive information about products or services offered by the advertiser. Most users are naturally resistant to such advertising because the act of clicking through interrupts the user's Web navigation session. For example, a user might readily click through a link to read a news story in more detail while visiting the Foxnews.com web site, but a user would be hesitant to leave the Foxnews.com web site while reading of the news to get information about a surveillance camera or perfume. This makes sense if one considers that a person viewing television often uses the commercial breaks as an opportunity to get up and do other activities for the duration of the commercial break. It is rare that an individual intentionally views advertising while doing something else.

One technique to get a user to view advertising is to provide some sort of incentive. Thus, J. Mankoff, Method and System for Electronic Organization of Coupons, U.S. Pat. No. 6,385,591 (7 May 2001) discloses an electronic or virtual coupon which is obtained when a user selects a given link on a web page being displayed on a client machine. The link is an image link embedded in an advertising banner that is displayed on the web page such that user click-through on the banner automatically generates the virtual coupon. The virtual coupon is then saved to a file on the client machine. Thereafter, the virtual coupon is downloaded to a PDA via a communication link when the PDA is synchronized to the desktop. When the virtual coupon is downloaded to the PDA, it is automatically saved in a coupon file. The incentive here is the coupon which, supposedly, offers a discount or other reward for its use.

While such scheme offers a coupon as an incentive to click-through on a banner ad, it does not address the issue of interruption of user navigation. It would be desirable to provide a technique for alerting a user to information, such as advertising, and providing such information to a user without interrupting a user's navigation session.

### SUMMARY OF THE INVENTION

The invention provides a method and apparatus in which a user may be presented with an offer to receive additional information, such as via a banner ad during a Web navigation session. With the invention, the user may elect to receive such information without interrupting the a current navigation session. The invention preferably provides this capability through the use of an information delivery channel other than the users' browser. In the preferred embodiment, the user selects a banner ad and, as a result, a request is forwarded to the advertiser, asking the advertiser to provide additional information to the user. Such information is provided, for example, by email or other such delivery channels which do not interfere with the users' Web navigation session.

One advantage of this approach is that the user does not leave the current Web navigation session and is allowed to receive information that may be of interest, which the user can view at a later time and/or in a different matter. For example, the information may be delivered by surface mail, broadcast via a cable television distribution network, and/or stored via a set-top box using a personal video recorder, or any other such communications and storage mechanisms. The user may also receive physical items, such as samples. In this embodiment, the user clicks on an advertisement for a product, e.g. a laundry soap, and a sample is the product mailed to the user's physical address.

In some embodiments, user selection of an advertising banner or other such advertising element or information generating element makes use of a verified user address, such as a verified user email address, and operates in conjunction with a verified advertiser or other information provider. In this way, the service assures the user that the act of requesting information from an advertiser does not result in the user being inundated with unrequested and undesired advertising. Further, the verified advertiser, by agreeing to certain terms and conditions before being allowed to advertise, assures that the user's privacy is protected.

In a presently preferred embodiment, the invention comprises a method for providing electronic information, which comprises the steps of providing a user of an electronic device with access to a Web page hosted by a first party, which Web page includes content from the first party, and which also includes content from a second party. The content from the second party relates to a subject. When the user responds to the content from the second party, e.g. by clicking on the Web page, to request additional content on the subject, the user automatically accesses a destination address, and the requested additional content is automatically sent to a destination address for use by the user independently of the user's current Web navigation session.

### BRIEF DESCRIPTION OF THE DRAWINGS

FIG. 1 is a block schematic diagram of an electronic network;

FIG. 2 is a block schematic diagram of another electronic network;

FIG. 3 is a block schematic diagram of a user system;

FIG. 4 is a block schematic diagram of network architecture according to the invention;

FIG. 5 is a flow diagram according to a fist embodiment of the invention;

FIG. 6 is a block schematic diagram showing system architecture according to an alternative embodiment of the invention;

FIG. 7 is a flow diagram showing an alternative embodiment of the invention;

FIG. 8 is a flow diagram showing another alternative embodiment of the invention; and

FIG. 9 is a representative flow diagram showing a user experience according to an exemplary embodiment of the invention.

### DETAILED DESCRIPTION OF THE INVENTION

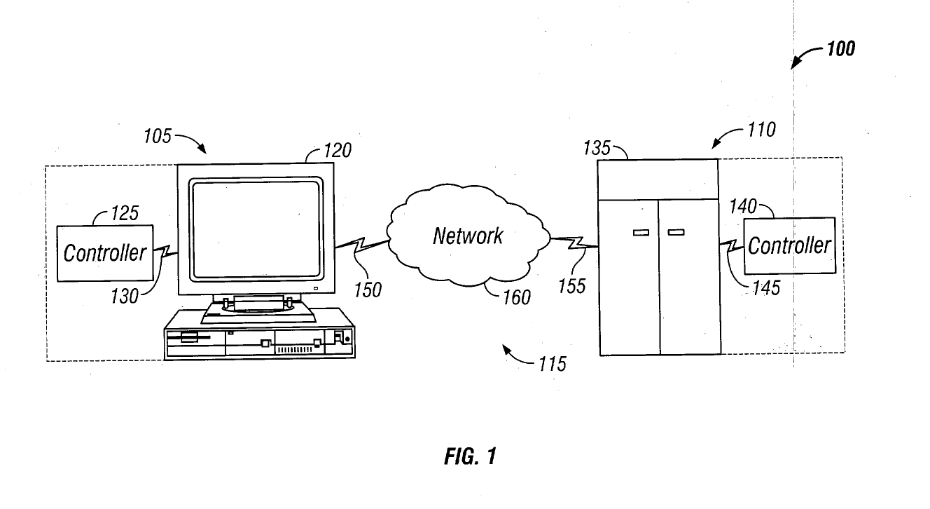

FIG. 1 is a block schematic diagram showing an electronic network 100 in which a user terminal 105 comprises a display 120 and a controller 125 interconnected via a communications link 130. The user terminal is in communication with an electronic network 115, which consists of a network mesh 160, via a connection 150. A server 110 is shown comprising of a server location 135, which is coupled to the network 115 via a network connection 155. The server includes a controller 140 which is connected with the server via a connection 145.

Those skilled in the art will appreciate that both the server and the user terminal are conventional items of manufacture, such as personal computers or other computers, that are well known in the art; and that the network could comprise any known electronic network, such as the Internet.

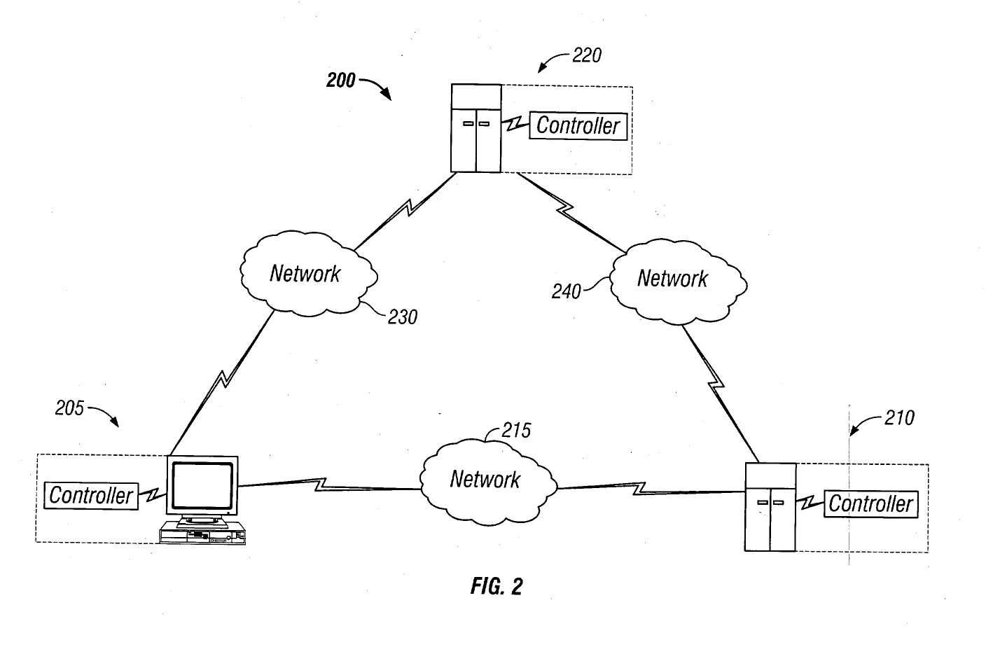

FIG. 2 shows a more sophisticated network arrangement 200 in which a user terminal 205 has access to multiple servers 210, 220. Each server, in turn, has access to each other server, as well as to the user terminal. The two servers and user terminal intercommunicate via various network connections 215, 230, 240.

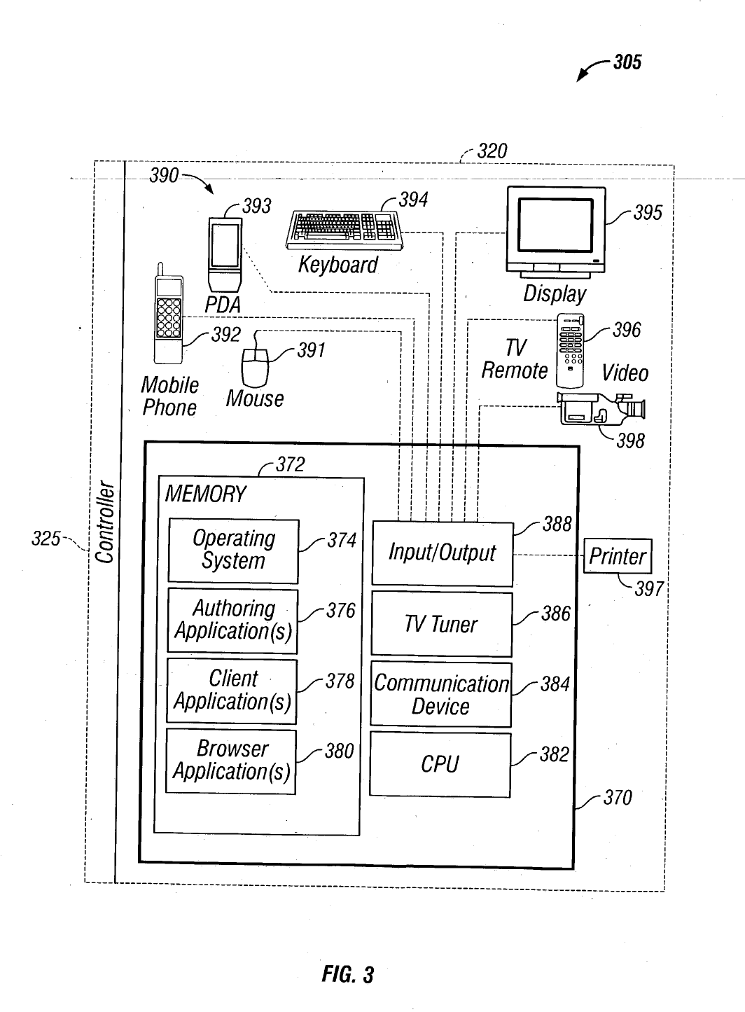

FIG. 3 shows a typical user terminal 305 which comprises a controller 325 that includes a CPU 382, a communication device 384, a TV tuner 386, and input/output circuitry 388. The CPU operates under control of various programs stored in memory 372, which programs can include an operating system 374, various authoring applications 376, client applications 378, and browser applications 380.

The input/output circuitry 388 allows the user terminal to communicate with such items as a printer 397 a video camera 398, a remote control unit 396, a display 395, a keyboard 394, a PDA 393, a mouse 391, and a mobile phone 392. The various elements which comprise the user terminal and input/output devices for use therewith are well known in the art and are not discussed in greater detail herein. Further, a typical user terminal may comprise either some or all of the above enumerated components.

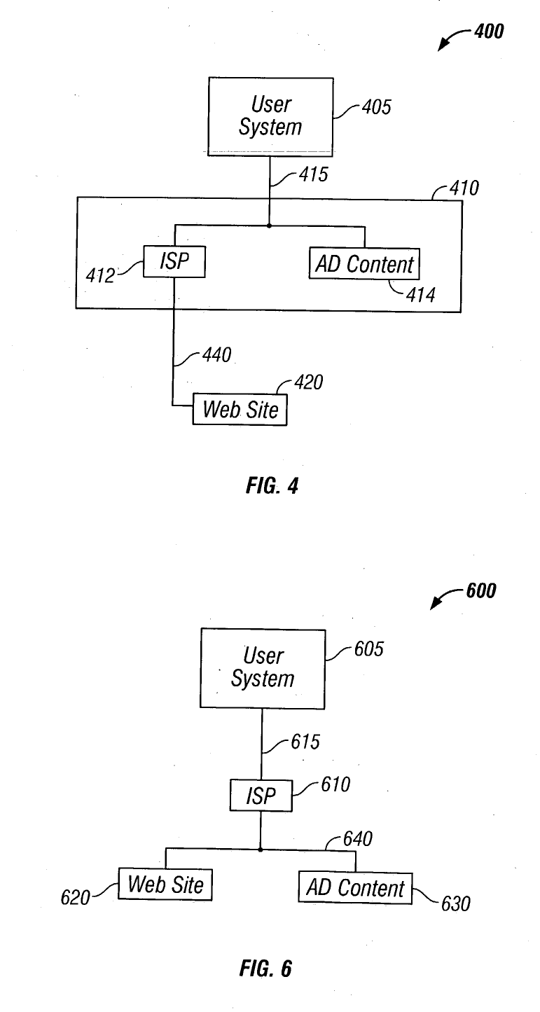

FIG. 4 is a block schematic diagram showing a system architecture 400 according to the invention, in which a user system 405 accesses a server 410 via a network connection 415. The server 410 includes an Internet service provider (ISP) 412 which hosts a user account and further includes an advertising content server 414. The user system accesses a particular Web site 420 via the user's ISP, which provides a point of presence for the user within an electronic network, such as the Internet. In this setting, the users' ISP establishes a connection 440 with the Web site for the user.

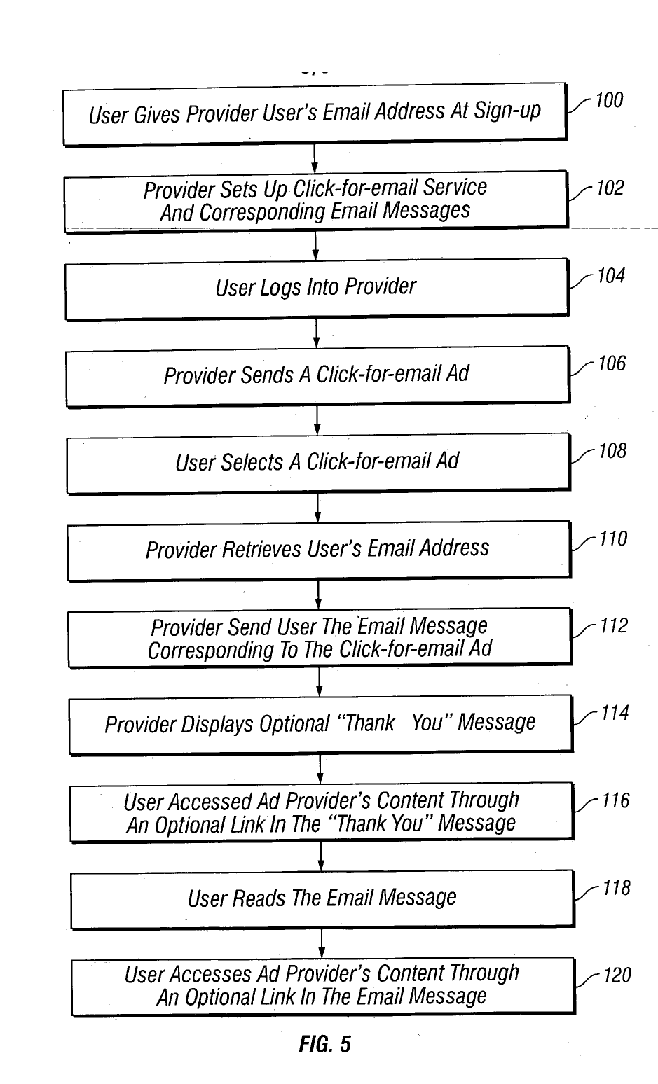

FIG. 5 is a flow diagram showing operation of the embodiment of the invention set forth in connection with the architecture shown in FIG. 4.

In operation, the user gives the ISP the user's email address during a sign-up sequence (100). The ISP sets up a click-for-email ad profile for the user (102), which includes corresponding email messages.

Thereafter, the user can log into the ISP (104) and access the various Web pages. When the user browses to a particular Web page that is enabled in accordance with the invention, the ISP sends, for example, a click-for-email ad to the user (106). The user selects the click-for-email ad (108), and the ISP retrieves the user's email address in responce thereto (110). The ISP then sends the user an email message corresponding to the selected click-for-email ad (112). The ISP displays a “thank you” message to the user (114). Such “thank you” message is optional, and it may be preferred not to provide such message if it distracts the user from the user's Web navigation session. The user may optionally access the ad provider's content through a link in the “thank you” message (116). The user may choose to read the email message (118). Finally, the user may optionally access the ad provider's content (or additional content beyond that provided with the email message) through a link in the email message (120).

Thus, the invention comprises the steps of notifying the user of the offer while the user is engaged in a Web browsing session, for example via a banner ad; the user requesting information in connection with the offer; and the user's ISP sending the additional information to the user through a delivery channel without interrupting the user's current Web browsing session.

While the above example describes the use of email as the means of notification of the user, into which a link may be embedded containing the information requested or with which the information may be sent, those skilled in the art will appreciate that other techniques for providing the requested information to the user may be used, such as the use of a physical mail delivery system such as the U.S. Postal Service, delivery through a television broadcast system to a user's set top box which is enabled with a personal video recorder, or shipment of a physical item such as a sample of a product, to the user.

In addition, the invention preferably comprises a mechanism that takes into consideration the security and privacy of the user's email and other information, and that requires that the ad provider and the user both be verified to the ISP. While this aspect of the invention is optional, it is preferred to provide such measures to protect the user's privacy and security, and such measures may be mandated by local laws. Thus, such techniques for notifying the user may be employed as, for example, providing information in the header, cookie, or server based mechanism. In the invention, the user's request may be provided directly to the service provider, or such information may be provided through a third party which verifies both the advertiser and the user. Finally, all contact with the advertiser, both with regard to requesting information and with regard to sending information, can be performed on behalf of the user by the ISP or by a third party authority.

Thus, the presently preferred embodiment of the invention can be thought of as comprising three steps, i.e. notifying the user of an offer, the user requesting information, and sending the information to the user without interrupting a user's current Web browsing session, which steps can be performed, for example, as follows:

Notification can be performed by a header within the Web page, for example which replaces the banner ad, a cookie which is placed on the user's computer, or a server based mechanism;

the request can be submitted by the user to the ISP or through a third party authority; and

sending can be performed by the ISP to the user or by a third party authority.

FIG. 6 is a block schematic diagram showing alternatively the embodiment of the invention 600, in which the users' system 605 is in communication with an ISP 610 through a network connection 615. The ISP provides access to a first server or servers 620 which comprises a Web site which the user is currently visiting, and a second server or servers 630 which provide advertising or other information to the user in connection with the navigation section. Communication between the ISP and the various servers is provided by a network connection 640. In the examples provided herein, the connection between the user system and the ISP may be via a network connection or via any other such connection, such as a dial up connection, cable modem, or otherwise.

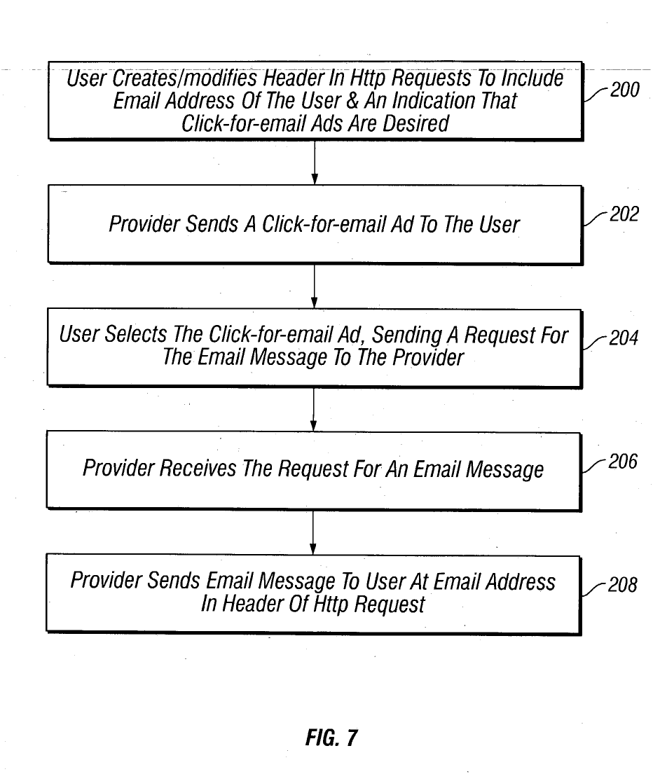

FIG. 7 is a flow diagram showing one embodiment of the invention in connection with the architecture shown in FIG. 6.

In FIG. 7, the user creates and/or modifies a header in an HTTP request tsuch that the request includes both the user's email address and an indication that the user wants to receive click-for-email ads (200). This act can be performed by the user through a simple dialog that the user is provided with when registering with the ISP, or such dialog may be provided from time to time by the ISP or by various Web pages navigated by the user. The ISP sends a click-for-email ad to the user (202) during a Web navigation session in connection with an enabled Web page navigated by the user. During such session, the user may select the click-for-email ad which, in turn, sends a request for the email message to the ISP (204). The ISP receives the request for the email message (206), and sends an email message to the user, using email addressed in the header of the HTTP request (208).

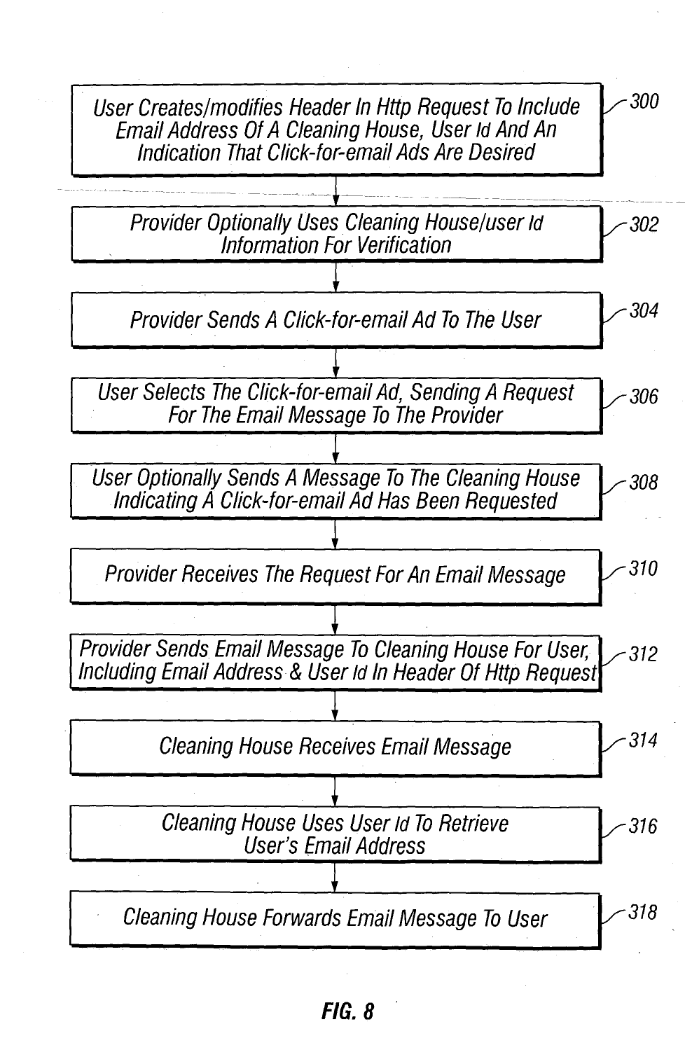

FIG. 8 is a flow diagram of an alternative embodiment of the invention in connection with the architecture shown in FIG. 6.

In FIG. 8, the user creates and/or modifies the header in an HTTP request (as discussed above) to include the email address of a clearinghouse, a user ID, and an indication that the user want to receive click-for-email ads (300). The ISP optionally uses the clearinghouse and the user ID information to verify legitimacy of the user (302). During the course of the Web navigation session, the ISP sends a click-for-email ad to the user (304). The user can select the click-for-email ad, which sends the request for an email message containing additional information associated with the click-for-email ad to the ISP (306). The user may optionally send a message to the clearinghouse, alerting the clearinghouse to the fact that the click-for-email ad has been requested (308). Such message may be optionally encoded to protect the security and privacy of the user. The provider receives the request for an email message containing additional information associated with the click-for-email ad (310), and sends the email message to the clearinghouse for the user, using the email address and user ID in the header of the HTTP request (312). The clearinghouse receives the email message (314), and retrieves the email address of the user with the user ID (316). The clearinghouse then forwards the email message to the user at the user's email address (318).

As discussed above, while email is shown as the channel for delivery of the additional information, those skilled in the art will appreciate that any other channels may be used, as discussed above. Further, while various interactions between the user, an ISP, and an ad source are shown, those skilled in the art will appreciate that the interaction and components of a system which incorporates the invention are a matter of choice. Key to the invention is the delivery of information to a user via a mechanism that does not interrupt the user's current Web navigation session.

The invention further comprises the following alternative features:

In one embodiment of the invention, when a user clicks on a banner ad, the request is sent to the clearinghouse at a network address within the Web page itself as inserted by the ISP. In alternative embodiments of the invention, the ISP does not need or get a user ID, but rather fills in an indirection so that the user ID is picked up from the user, or the clearinghouse recognizes the user IP address. This approach requires login or identification ahead of time, such as the receipt on an email message at boot up, or the use of a wallet.

The ISP can also provide the functionality of the invention without knowing the clearinghouse name by using another indirection, e.g. by trusting the clearinghouse to authenticate the user. In this case, the ISP could include a list of clearinghouses to which it responds, based upon its own vetting of the clearinghouses.

The clearinghouse may receive a request including the ISP address, and request the email message from the provider for the user. Alternatively, the clearinghouse can receive the email message and forward it to the user.

Various implementations of the invention also comprehend the use of cookies. Cookies themselves are well known in the art and are not discussed in further detail herein. In these embodiments of the invention, the header information is extracted from the user by accessing a cookie that is available to any provider of click-for-email ads.

The following information can be retrieved from the cookie: the user's email address, the clearinghouse email address, the user ID at the clearinghouse, and/or an indication that the user want to receive click-for-email ads. For example, the Verizon, Earthlink, or AT&T cookie placed on the user's computer can be accessible by any provider. When the user accesses any of these services, the cookie is changed to enable click-for-email ads and list one of the forgoing, e.g. Verizon, Earthlink, or AT&T, as the recipient. Such recipient may note the user's IP address and correlate it with the user for which an email address may already be on file.

The invention also comprehends that, in server based implementations, header information is broadcast by the user's ISP whenever the user is online, or such information may be broadcast regularly during online times if the user is constantly online or online for a long time. Alternatively, an ad provider could query an ISP as to when a user accesses the ISP, or the ISP could query one or more of a limited number of verification servers based on athe user's IP address, when the user is logged into the verification server.

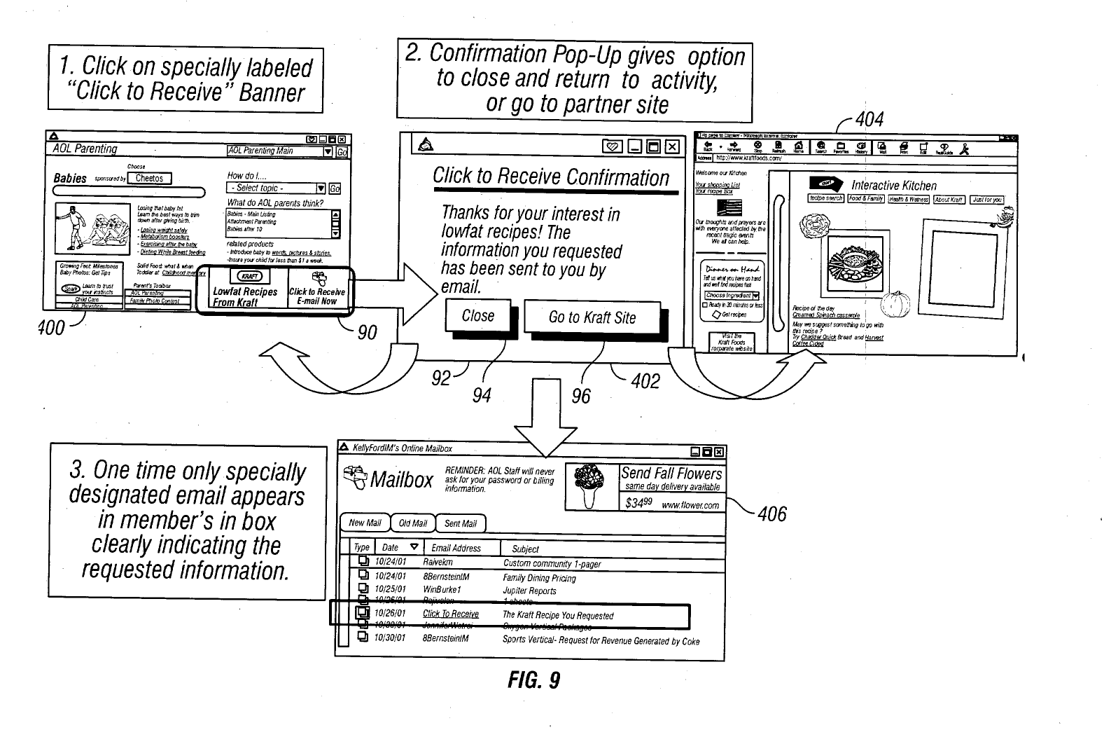

FIG. 9 is a representational flow diagram of the user experience in connection with an exemplary embodiment of the invention. In the example, a user is visiting the Web site AOL Parenting (400). A banner ad is provided on the Web page showing that low-fat recipes are available from Kraft. In this embodiment of the invention, the user clicks on the special labeled click-to-receive banner 90. In this embodiment of the invention, a confirmation pop-up 92 is provided to the user which gives the user the option to close and return to a current activity or go to the partner site (402). If the user selects close 94, then the pop-up closes and navigation by the user at the AOL parenting web site is uninterrupted. If the user clicks the “go to Kraft” site button 96, then the user is taken directly to the Kraft site (404). The user is also sent an email of the requested information, which shows up in the user's in-box in a manner clearly indicated, so that the user is able to identify it as being requested information (406).

Those skilled in the art will appreciate that the forgoing is an example of certain embodiments of the invention but that other implementations are possible. For example, the confirmation pop-up is optional and may not be provided. Further, the click-to-receive button may be provided only to those individuals who have registered with the click-to-receive service. If the user has not registered, he may be provided with an enrollment button for the click-to-receive service that accompanies the banner ad. Further, the pop-up discussed above can include additional options, such as method of delivery, delivery address information, and other preferences that the user may set. Alternatively, such preferences may be set at the time of enrollment.

Systems implementing a click-to-receive ads process can determine a user's email address in a variety of ways depending on the environment.

In a closed environment, such as that provided by a subscription based content provider, the content provider may have access to a user's email address. For example, a user may have to log in to the content provider before receiving content, and the content provider may have a user profile containing the user's email address. The content provider may also prompt the user for an email address when the user logs in. Because the content provider provides the ads and receives the user's clicks, the content provider knows what ad content to email to the user, and also knows the user's email address.

In a subscription service in which a user logs in to an ISP, the environment may not be closed. However, the ISP may have a user profile that includes the user's email address, or the ISP may prompt the user for an email address. The ISP may also monitor the content delivered to the user through the ISP and may, as a result, monitor when the user clicks in a click-for-email ad. The ISP may then communicate with the provider of the click-for-email ad to obtain the advertising content to send to the user in an email. This may require the ISP to track information for each user.

Alternatively, the ISP may rely on the ad-provider, e.g. in a Web site hosted by another ISP, to send a message when a user clicks on a click-for-email ad. The ad provider may generate the ad content and send it to the ISP that is providing the connection for the user. The ad provider should have this address because it had received clicks from, and sent content to, the user through that ISP. The ISP does not need to monitor the user's activity and, when the message is received from the ad provider, the ISP can forward it to the user via email. The message presumably can include the IP address for the user, so that the ISP can look that connection up and determine the identity of the user. If the user has supplied an email, or signed up for click-for-email ads, then the service provider already has the email address.

In an environment in which a user accesses the Internet through an ISP that does not require log-in, the service may still present the user with an introductory screen. The introductory screen may offer the user the option of participating in a click-for-email-ad service, and request the user's email address. Such a screen may be provided, for example, when the user dials in to an ISP. The ISP may then use the above described procedure for accepting and delivering messages from ad providers.

Yet another implementation may be more advantageous in direct connection environments in which a user may have a continuous connection such as, for example, that provided by a cable modem. In such an environment, or in the other environments discussed, a user's software may present the user with an introductory screen asking the user if he wants to receive click-for-email ads. If the user agrees and provides an email address, the user's software may share the email address with ad providers. For example, when a user clicks on a click-for-email ad, the ad provider can query the user's machine to ensure that the user has signed up to accept click-for-email ads and has provided an email address at which to receive requested information.

In all of these implementations, access to an email address may be conditioned on the user's consent. Further protections may also be built in. For example, introductory screens or queries from ad providers, could require some verification that a user is supplying his own email address. In one implementation, advertisers and content providers may create a large database that includes the email addresses for every user that has signed up for click-for-email ads. More importantly, to be entered on that database, a user must verify their his address, or the system may verify it by, for example, sending an email and requiring a response.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for providing requested information, comprising the steps of:
providing to a user of an electronic device access to a page hosted by a first party, said page comprising content from said first party and content from a second party, wherein said content from said second party relates to a subject;
said user responding to said content from said second party to request a message which comprises additional content on said subject;
receiving said user's request for a message;
accessing automatically a destination address for said message; and
providing automatically said requested message to said destination address for use by said user in a manner that does not interfere with use by said user of said content from said first party.

2. The method of claim 1, wherein said content from said second party comprises a banner advertisement, and
wherein said user responds to said banner advertisement by selecting said banner advertisement.

3. The method of claim 1, wherein accessing automatically said destination address for said message further comprises the step of:
receiving said destination address in said request for said message.

4. The method of claim 3, wherein said destination address comprises:
an address selected from a group consisting of a message that comprises any of an electronic address for said user and an electronic message address for a message server; and a physical address.

5. The method of claim 1, wherein accessing automatically said destination address for said message further comprises the step of:
accessing said destination address from said electronic device.

6. The method of claim 1, wherein accessing automatically said destination address for said message further comprises the step of:
accessing said destination address from a server that is in communication with said electronic device.

7. The method of claim 1, wherein accessing automatically said destination address for said message further comprises the step of:
accessing said destination address from a user profile.

8. The method of claim 1, further comprising the step of:
verifying said destination address.

9. The method of claim 8, wherein verifying said destination address further comprises the step of:
comparing said destination address against a list of accepted addresses.

10. The method of claim 1, wherein providing automatically said requested message to said destination address for use by said user further comprises the step of:
providing said requested message to a message server for delivery by said message server to said user.

11. The method of claim 1, further comprising the step of:
inhibiting a third party from acquiring a message address of said user.

12. The method of claim 11, wherein inhibiting said third party from acquiring said message address further comprises the step of:
encoding said message address.

13. The method of claim 1, wherein providing access to said page further comprises the step of a server providing access to a page hosted by said server that comprises a banner advertisement from said second party, wherein said user selects said banner advertisement;
receiving said request for said message further comprises the step of receiving at said server said request that is generated and sent in response to said user selecting said banner advertisement, wherein said user is logged in to said server using said electronic device;
accessing automatically said destination address for said message further comprises the step of accessing an address for said user from a profile for said user; and
providing automatically said requested message to said destination address for use by said user further comprises the step of said server sending an electronic mail message to said accessed destination address for said user.

14. The method of claim 1, wherein providing access to said page further comprises the step of a server providing access to a page hosted by said server that comprises a banner advertisement from said second party, wherein said user selects said banner advertisement;
receiving said request for said message further comprises the step of receiving at said server said request that is generated and sent in response to said user selecting said banner advertisement; and
providing automatically said requested message to said destination address for use by said user further comprises the step of said server sending an electronic mail message to said destination address for said user.

15. The method of claim 14, wherein accessing automatically said destination address for said message further comprises the step of accessing said destination address from within said request for said message.

16. The method of claim 15, wherein said request for said message is generated and sent in response to said user selecting said banner advertisement, is sent from said electronic device to a message server, and is then forwarded by said message server to said server, wherein receiving at said server said request that is generated and sent in response to said user selecting said banner advertisement further comprises the step of receiving a forwarded request.

17. The method of claim 1, wherein a communication network is used in providing access to said page and in receiving said user request.

18. An apparatus for providing requested information, comprising:
first access circuitry to provide to a user of an electronic device access to a page hosted by a first party, said page comprising content from said first party and content from a second party, said content from said second party relating to a subject, wherein said page allows a user to respond to said content from said second party to request a message that comprises additional content on said subject;
receive circuitry to receive a user's request for a message;
second access circuitry to access a destination address for said message automatically; and
providing circuitry to provide said requested message to said destination address automatically for use by said user.

19. The apparatus of claim 18, wherein at least one of said first access circuitry, said receive circuitry, said second access circuitry, and said providing circuitry comprises a processor.

20. The apparatus of claim 18, wherein at least one of said first access circuitry, said receive circuitry, said second access circuitry, and said providing circuitry comprises a storage device having instructions stored therein.

21. A method for providing requested information, comprising the steps of:
providing content from a first party for inclusion into a page hosted by a second party, said content from said first party relating to a subject;
said user responding to said content from said first party to request a message that comprises additional content on said subject;
receiving said user's request for a message;
accessing automatically a destination address for said message; and
providing automatically said requested message to said destination address for use by said user in a manner that does not interfere with use by said user of said content from said first party.

22. The method of claim 21, wherein said content from said first party comprises a banner advertisement; and
wherein said user response to said banner advertisement further comprises the step of selecting said banner advertisement.

23. A method for providing reqeusted information, comprising the steps of:
providing access to a message address;
using an electronic device to access a page hosted by a first party which comprises content from said first party and content from a second party, wherein said content from said second party relates to a subject;
responding to said content from said second party to request a message that comprises additional content on said subject; and
automatically sending said message in a manner that does not interfere with use by said user of said content from said first party;
wherein said message is sent in response to receiving said user request by accessing said message address.

24. The method of claim 23 wherein said content from said second party comprises a banner advertisement; and
wherein said user response to said banner advertisement further comprises the step of selecting said banner advertisement.

25. The method of claim 24, wherein providing access to said message address further comprises the step of said user logging in to a server to provide said server with access to said message address.

26. The method of claim 25, further comprising the steps of:
receiving automatically said requested message; and
accessing said received message.
